(19) United States
(12) Patent Application Publication
(10) Pub. No.: US 2006/0115266 A1
(43) Pub. Date: Jun. 1, 2006

(54) All-optical protection signaling systems and methods in optical communication networks

(76) Inventors: Gil Levi, Hagor (IL); Beni Kopelovitz, Kfar Saba (IL)

Correspondence Address: DR. MARK FRIEDMAN LTD.;c/o Bill Polkinghorn, 9003 Florin Way, Upper Marlboro, MD, 20772, US

(21) Appl. No.: 10/999,998

(22) Filed: Dec. 1, 2004

(51) Int. Cl. H04B 10/08

(52) U.S. Cl. 398/19

(57) ABSTRACT

All-optical system and methods of synchronizing and signaling across an optical network in order to coordinate protection schemes on an end-to-end basis. The system comprises a switch module operative to provide transparent optical protection signaling and switching in response to a failure indication and a mechanism operative to provide the failure indication. In one embodiment, the method comprises the steps of detecting a failure in a primary link of the network and transparently signaling by optical means to at least one side of the primary link that the failure has been detected, thereby facilitating switching of optical traffic from the primary link to a protection link based on an transparent optical switching protocol.

### FIELD AND BACKGROUND OF THE INVENTION

The present invention relates to optical communication systems, and in particular to all-optical protection signaling systems and methods enabled by protection signaling protocols in such systems.

FIG. 1 shows schematically a basic, widely known optical communication system 100 that comprises two optical links (optical fibers) 102 and 104 connecting a service between a source 106 to at least one destination 108. 102 is a regular “working” link or primary link, and 104 is a protection link or a secondary link. In case each link is implemented as a “fiber pair” or bi-directional link, one fiber is used for the transmit signal and another fiber is used for the receive signal. The source has a first source transceiver or transponder 110 operative transmit and receive signals on link 102 and a source extra traffic transceiver or transponder 112 operative to transmit and receive signals on link 104. For simplicity, “transponders” may henceforth also represent “transceivers”. Customer 108 has a first customer transponder 114 connected to link 102 and a customer extra traffic transponder 116 connected to link 104. Normal data traffic between source and customer takes place on link 102. In case of a failure (e.g. a cut) in working link 102, the traffic is rerouted to protection link 104. After link 102 is repaired (i.e. restored to its normal functioning state) data traffic is routed back to it from the protection link.

In existing optical communication systems, the detection of the failure in the regular link and the restoration of its normal functioning, or in other words the protection signaling protocol is performed electrically. This makes the system non-transparent, where a different set of optical to electrical and electrical to optical converters are needed for each type of protocol or bit-rate. This also makes the system more expensive, since the need for electrical to optical and optical to electrical conversions is very expensive if these signals are at high bit rates.

There is thus a widely recognized need for, and it would be highly advantageous to have, all-optical protection signaling systems and methods, more generally referred to as “all-optical protection signaling protocols”. Such systems and methods should enable deployment of a “transparent” optical protection system that can serve to protect any service from any point to any point, thus adding the ability to cost effectively provide protection of services that are not currently protected.

### SUMMARY OF THE INVENTION

The present invention is of an all-optical protection signaling system and method used in an optical communication system.

According to the present invention there is provided in an optical communications network that includes a plurality of regular (sometimes also referred to as “normal”) traffic links and at least one protection link, each link connected at each of a transmitting and a receiving side to a protection system, an all-optical protection signaling method comprising the steps of: detecting a failure in at least one of the regular traffic links, thereby identifying at least one failed link; optically notifying a transmitting side of the failed link about the failure; and switching traffic carried by the failed link to the at least one protection link.

According to the present invention there is provided a method for all-optical protection signaling in an optical communication network comprising the steps of: detecting a failure in a primary link of the optical communications network and transparently signaling by optical means to at least one side of the primary link that a failure has been detected, thereby providing switching of optical traffic from the primary link to a protection link based on an transparent optical switching protocol.

According to the present invention there is provided a system for all-optical protection in an optical network comprising a switch module operative to provide transparent optical protection signaling and switching in response to a failure indication, the protection switching including the switching of optical traffic from at least one primary link to at least one protection link, and a mechanism operative to provide the failure indication, whereby the transparent optical protection switching does not require any electronic messages.

According to one feature in the system for all-optical protection in an optical network of the present invention, the mechanism that provides a failure indication includes an optical taps module operative to tap into optical traffic carried by each primary link and operative to provide an output optical tap signal, a photodetector module operative to measure each tap signal and to provide an optical signal measurement, and a control module operative to trigger the optical protection switching in response to the optical signal measurement.

### BRIEF DESCRIPTION OF THE DRAWINGS

The invention is herein described, by way of example only, with reference to the accompanying drawings, wherein:

FIG. 1 shows schematically a basic, widely known optical communication system;

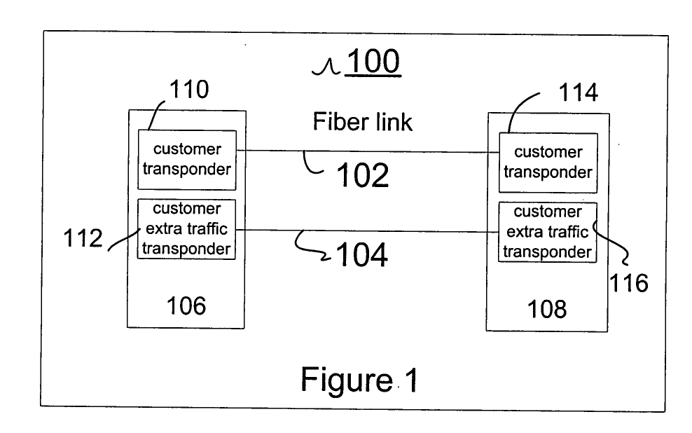

FIG. 2 illustrates the difference between dual ended and single ended protection;

FIG. 3 shows schematically an optical communications system that supports optical channel protection;

FIG. 4 shows an example of a block diagram for an all-optical 1:N protection system with photodetectors and associated circuitry;

FIG. 5 shows the exemplary optical switch functionality for a 1:N protection system, relating to each input or output as a fiber pair for receive and transmit signals;

FIG. 6 shows an exemplary scenario for a 1:1 bi-directional dual ended protection (one fiber cut);

FIG. 7 shows an exemplary state machine that implements dual-ended 1:1 bi-directional mode protection.

### DESCRIPTION OF THE PREFERRED EMBODIMENTS

The present invention is of a novel, all-optical dual-ended protection signaling system and method for detecting and reporting a failure (e.g. a cut) in an optical communication link (fiber) and for switching the data traffic to a protection link. The system and method in the present invention also are able to identify the restoration to operational status of the failed link and allow the traffic to be restored, either automatically or upon demand, back to the originally used primary link. The method for use of the system is referred to henceforth also as a “protection signaling protocol”. Upon restoration of the integrity of the primary optical communication link, the all-optical protection signaling protocol is used to restore the traffic from the protection link back to the primary communication link. In contrast with existing dual-ended protection schemes in which the signaling is at least partly electrical, in the present invention there is no need for electrical signaling to be involved in the protection signaling protocol.

The basic principle underlying the all-optical protection signaling protocol of the present invention involves use of special optical signals carried between the two ends of the link. These special optical signals are carried using only the fibers that carry the traffic between the two ends. This is done in a transparent manner so as not to interfere with the signals passing in the fiber. The special optical signals are passed transparently from end to end in the link without the need to change the infrastructure of the optical network. The all-optical protection signaling protocol of the present invention is applicable in a wide range of scenarios, some of which are illustrated in detail below.

The present invention provides in a preferred embodiment a 1:N (or its simplified case of 1:1 where N=1) dual-ended bi-directional protection system. The purpose of this system is to provide end-to-end protection of an optical link or links. This is done using a shared protection scheme whereby one link is used as a redundant link to protect N other links (where N can be 1, 2, . . . N). These links will usually pass through geographically separate routes, insuring the survivability of at least one of the links during any single failure along the links (either fiber cut or equipment failure along the link). A simple (and very common) particular case will be that of N=1, when two links are provisioned from one site to another.

The main difference between single-ended and dual-ended protection of a bi-directional link is that in case of dual-ended protection, when an optical link carried by a fiber pair fails, both the transmit and the receive signals are switched to the protection route simultaneously, whereas if the protection of a bi-directional link is single-ended, in a case where only one fiber is cut (triggering protection), only that fiber will be switched to protection. In such cases the transmit signal and the receive signal will no longer travel together but rather go through different paths altogether. Single-ended protection has some disadvantages: 1) different delays and latencies between the transmit and receive of the signal; 2) inability to connect monitoring equipment along the link if such equipment requires both the transmit and receive signals to be monitored by the monitoring equipment (due to not having both the transmit and the receive signal present in the same location to be connected to the monitoring equipment); and 3) inability to replace faulty equipment which carries both the transmit and receive signals in the same unit without interrupting the optical signal again during the replacement (in addition to the interruption which occurred when the fault caused the protection of one of the signals making them pass through different paths in the first place), etc.

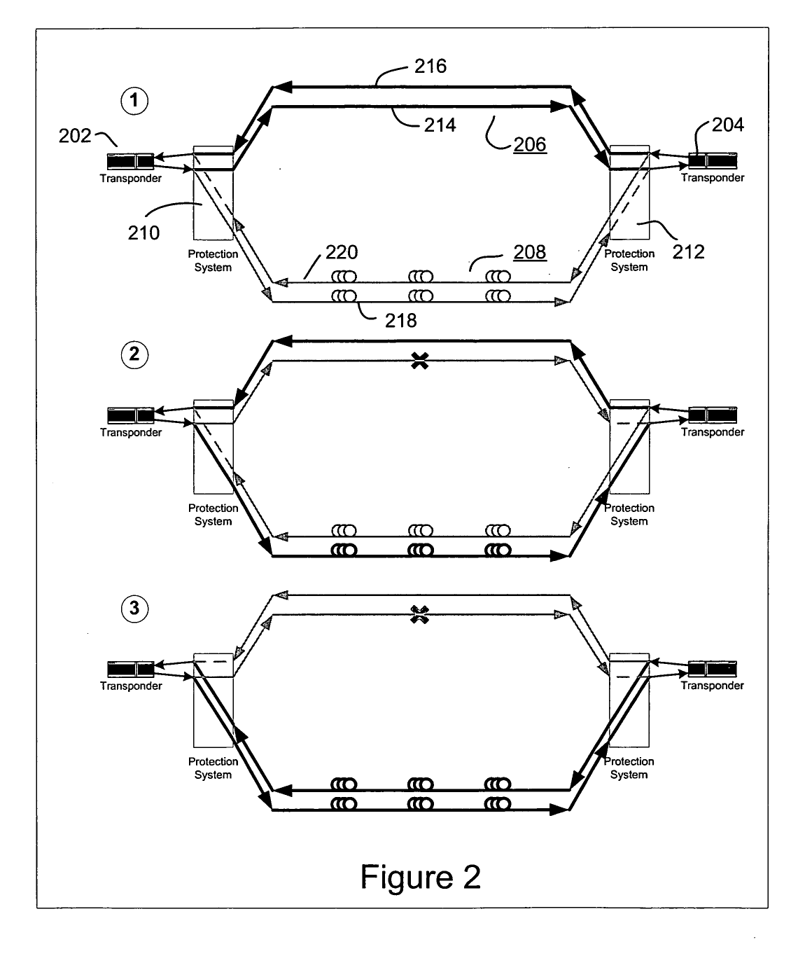

FIG. 2 illustrates the difference between dual ended and single ended 1+1 protection. A 1+1 protection mode is a mode by which the transmitted signal is split to two outgoing fibers simultaneously. The two received incoming signals are then examined, and only one of them is allowed to pass to the receiver while the other is blocked. The figure shows 3 “scenes” marked 1-2-3. Scene 1 shows two transponders 202 and 204 connected in 1+1 protection, where each side transmits to both a primary (or top) link 206 and to a protection (or bottom) link 208 through respective protection systems 210 and 212. That is, each link carries both transmit and receive signals in separate fibers. Exemplarily, link 206 carries transmit signals 214 and receive signals 216, and link 208 carries transmit signals 218 and receive signals 220 in respective fibers. With no failure in primary link 206, both transmit signals 214 and receive signals 216 are selected by the respective protection system (210 or 212) to pass to the receiving transponder through link 206. Scene 2 shows a scenario describing the behavior of the network if this network was protected by a single-ended protection system, in case of a single fiber cut (in this case fiber 214) in the primary link. When the protection system 212 senses the fiber cut, it switches the reception on the local side of the link only from the primary link which has failed to the protection link (i.e. reception is switched to fiber 218). Thus we have a resulting case where the actual signals passing between the two ends of the link pass via the primary link in one direction (fiber 216) and via the protection link in the other (fiber 218).

Scene 3 shows a dual-ended protection system behavior in case of a similar single fiber cut (in this case also fiber 210) in the primary link. We can see that in this case both transmit and receive signals are switched by both protection systems to pass through the protection link (fibers 220 and 218) in both directions.

Optical Layer Protection System

In cases where a transparent optical link needs to be protected in the optical layer, protection switching must be done in the optical domain. This means that the protection method does not look “into” the signal, but rather protects the entire link transparently, regardless of the protocol or data rate of the signal being carried on the optical link.

Such transparent protection provides some substantial benefits: allowing the seamless upgrade of the optical link to higher bandwidth or other protocols without the need to upgrade the optical protection equipment; providing cost effectiveness in higher bandwidths by providing cheaper means of optical protection for signals and services; and allowing significantly smaller footprint of the protection equipment needed to be housed for the purpose of protecting the optical links.

Signaling Required Between Link Ends

In order to implement dual-ended protection switching in bi-directional links, the two ends must communicate with each other to synchronize the switch to protection from both sides of the link. This is mainly true for the cases in which only one side senses the failure and must notify the other side, which is unaware that a failure has occurred. Both sides must then switch together to the protection link.

Transparent Signaling via the Link Fibers

In many cases there are no reliable appropriate communication means between the two ends of the links other than the fibers that make up the links themselves. This means the signaling between the two ends of the link must be carried transparently using the same fibers. In order to implement the signaling using only the fibers between the two ends of the links, one must implement a solution to pass the signaling optically and transparently in the same fiber pairs (main pairs and the protection pair). Such “transparent optical signaling” is provided by the present invention both when implementing fiber protection (when only fibers connect between the two ends of the link) and when implementing optical channel (OCh) protection (see below regarding the difference between fiber protection and optical channel protection).

Enabling Optical Channel (OCh) Protection

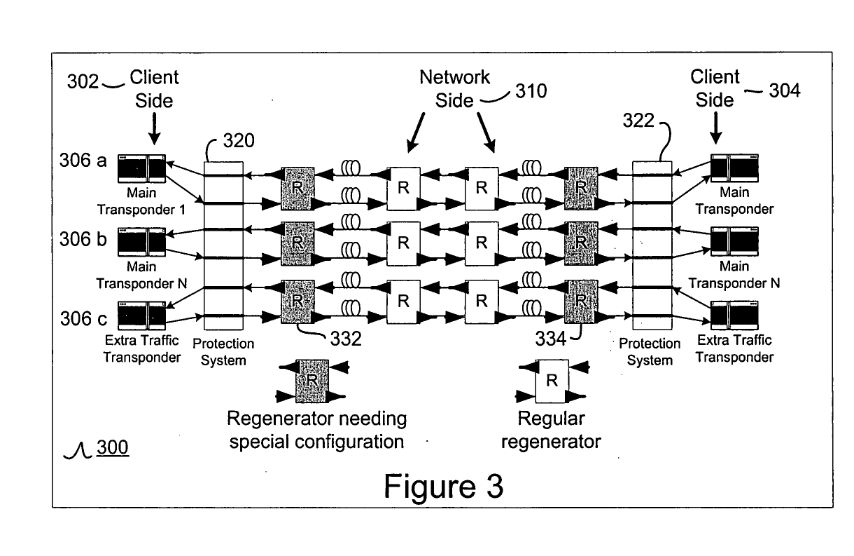

In OCh, regeneration equipment (such as transponders, transceivers, amplifiers, etc., generally referred to hereinafter as “transponders”) is used along the link to enable the distances and abilities/performance/quality required from the signal to reach the other end of the link. FIG. 3 shows schematically an optical communications system 300 that supports OCh protection. System 300 comprises two client sides 302 and 304, each including respective transponders 306a-c and 308a-c, the two client sides connected to a network side 310 through links that include a plurality of repeaters (regenerators) interconnected as shown. Two protection systems 320 and 322 are located on all links at each of respective client sides 302 and 304. In order to enable OCh protection, where repeaters and regenerators of different types are connected along the link on the network side, simple power measurements of the optical signals are not sufficient. This is because in almost all cases of standard transponders (regenerators), like SONET/SDH (which is the most common optical transport standard deployed), when a fiber is cut in one place, the regenerator will not stop transmitting once it detects that the input signal has stopped. Rather, the regenerator will still transmit an optical signal with information included in that signal that an error has occurred, according to the specifications of the appropriate protocol being used. This would make a measurement of optical power meaningless, since optical power will still be present in the link, except for the small part of the link between the fiber cut and the closest adjacent regenerator. For this reason the optical links used to connect between the two protection systems at each end must be configured in a special way, described in more detail below. The configuration is done to the regenerators closest to the protection system only and in one direction towards the protection switch only, and each such regenerator must be configured to stop the optical signal from going into the protection system if certain errors (as specified by the network operator) have been detected along the link by previous regenerators. This will cause each detected error along the link, such as a fiber cut or repeater malfunction, to stop the optical signal from going into the protection system and allow that system to recognize that a failure has occurred. In the exemplary system of FIG. 3, the configuration is done to repeaters/regenerators 332 adjacent to protection system 320, and to repeaters/regenerators 334 adjacent to protection system 322. It is important to notice that only the adjacent regenerators must be configured in this special way, as seen in FIG. 3.

Block Diagram and Description of an Exemplary Optical Protection System

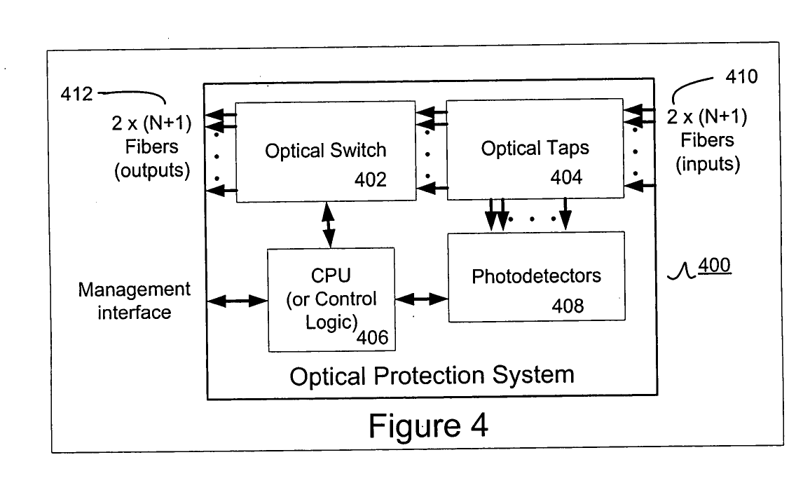

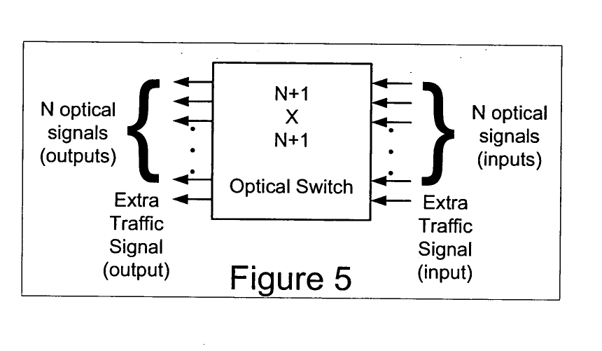

FIG. 4 shows an example of a block diagram for an all-optical 1:N protection system 400. The system comprises an optical switch module 402, the switch module in the most general case an (N+1)×(N+1) switch where N=is any integer, an optical taps module 404, a central processing unit (CPU) or control logic module 406 and a photo-detector module and associated circuitry 408, interconnected as shown. This does not require full connectivity of the optical switch. However, a minimal connectivity is required between each signal and its fixed pre-assigned link and between each normal signal and the protection link. An exemplary switch module 402 is shown in more detail in FIG. 5. In terms of optical signals, system 400 is connected to input and output fibers (410 and 412 respectively), which carry traffic to be protected by the system. All input fibers are then connected to the optical taps, which tap a small percentage of the optical signals into the photo-detectors, and pass the signals into the optical switch. The optical switch is then responsible to send each signal into its appropriate output fiber, according to the state of the system and the network connected to it (see state machine example below). In addition, the optical switch module is also responsible to create the optical signaling messages, when needed, to communicate with the protection system on the other end of the optical link being protected. The photo-detectors measure the optical signal strength of each fiber entering the system and pass the measurements to the central processor (CPU or control logic), which on this basis can trigger the optical protection switching, as needed by the status of the signals. The optical power of each fiber coming in to the protection system is usually compared with a preset threshold that determines the operational status of that fiber or signal. If the threshold is crossed, the CPU or control logic will then act to protect the failed signal, as pre-configured into the protection system in advance.

FIG. 5 shows the optical switch functionality for a 1:N protection system. For each optical protection group, which shares one protection link (or a number of protection links for a case of M:N protection, which is the generic case for M=1 in 1:N protection) there are two such switches needed in a protection system. The first connects the networks side inputs to the client side outputs, and the second connects the client side inputs to the network side outputs, thus achieving one end of a protected link network protecting bi-directional signals using two-fibers per link (one for the transmit and one for the receive). If for example, the protection system is built to protect 8 links using 2 protection links in a 1:4 scheme, the optical protection system will include 4 5×5 optical switches to achieve the needed functionality. The optical switch must be able to connect all input signals to be protected in each group (in this example's case we have 4 signals per group) to all available protection links for that group, in this case 1 link per group). The number of optical switches would be 4 in this case, since we are protecting a total of 2 groups (8 links divided into 2 groups of 4 links, each group protected by one protection link). In addition, in order to support “transparent” optical signaling, the optical switch must also be able to block signals in order to be able to create the optical messages needed to communicate with the other side of the link.

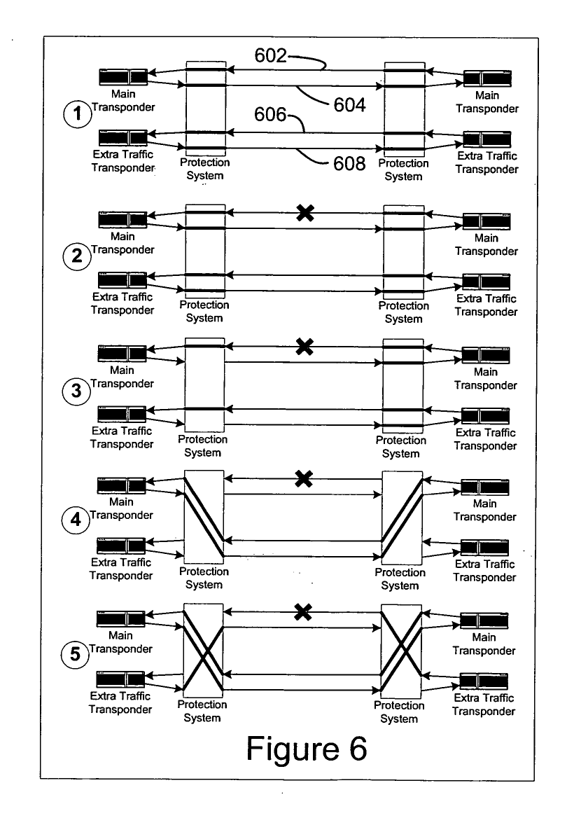

FIG. 6 shows an exemplary scenario for a 1:1 bi-directional protection (one fiber cut). In the bi-directional 1:1 protection mode, the transmit signal is sent through the primary path of the link (fibers 602 and 604), and optionally another transmitter is used to pass another signal using the secondary, or protection, path of the link (fibers 606 and 608). This other transmitter usually carries what is referred to as “extra traffic”, which is low priority traffic that is passed to the other side of the link when no failure occurs in the main link. When a failure occurs in the main link, the extra traffic, being low priority, is dropped and the alternative path is then used to pass the main traffic. For this to be successful, both sides of the link must be synchronized so that when the failure is detected, both sides will drop the extra traffic and connect the main transponder to the alternative path instead of the main path. The way the protection is done is now explained in detail, using “scenes” marked 1 to 5.

In scene 1, the primary link is used by main transponders to pass the main traffic between a left side system and a right hand system, while the secondary link is used by the extra traffic transponders to pass the extra traffic. In scene 2, one of the fibers (602) carrying the main traffic is cut. The left system detects this fiber cut and temporarily stops all transmission to the right side (an example of one possible signaling message) in order to notify the right side of the failure (Scene 3). The temporary stop is shown by the removal of the transmitted signal in the left side protection system. After a predefined time (which is longer than the propagation time of the induced optical power cut in Scene 3), both sides switch to the secondary link (Scene 4). Then to complete the switch, the extra traffic transponder on both sides is switched to the primary link to facilitate the status monitoring and failure fix of the primary link (Scene 5).

If the fiber cut had been detected on one of the secondary link fibers, the event would have been notified to management, but no protection switching would have been triggered.

State Machine Example for 1:1 Protection

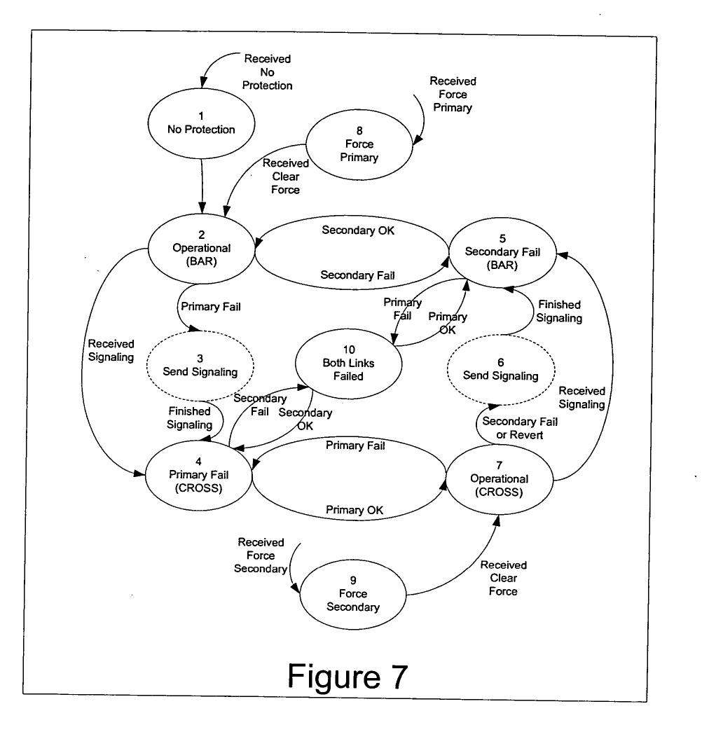

FIG. 7 shows an exemplary state machine that implements dual-ended 1:1 bi-directional mode protection. This state machine, when implemented by the protection system at each end of the link, will protect the signals passing through between the two end transponders in a 1:1 mode, providing dual ended protection to the link. This implementation also makes sure that no misconnection (unwanted interference between the traffic of one client and another, be it extra traffic or regular traffic) will ever occur between the main signal and the extra traffic signal, since the implications of such misconnections are unwanted and are therefore avoided at all times. The state machine is preferably implemented in the control logic of the optical protection system shown in FIG. 4. The following table explains the different events handled by the system:

| Term | Definition |
|---|---|
| Enable | The user has given a command to start protection |
| Protection | |
| Received No | The user has given a command to stop protection |
| Protection | |
| Force Primary | The user has given a command to move signal to the |
| | primary link |
| Force | The user has given a command to move signal to the |
| Secondary | secondary link |
| Revert | The user has given a command to move signal back to |
| | the primary link |
| Primary Fail | The signal level measured at the primary link input is |
| | below the set threshold |
| Primary OK | The signal at the primary link input has returned to |
| | operation status |
| Secondary | The signal level measured at the secondary link input is |
| Fail | below the set threshold |
| Secondary OK | The signal at the secondary link input has returned to |
| | operation status |

Returning now to FIG. 7, the state machine has a number of different states, marked in the figure by numbers 1-10. The states are now explained in detail.

| | |
|---|---|
| State 1: No Protection | Switch: bar |

In this state protection is not enabled. The switch remains at its default configuration which is bar.
Events:

Move to state 2. Protection has been enabled.

| | |
|---|---|
| State 2: Operational (BAR) | Switch: bar |

This state is the first state in which protection is enabled, and is the state in which everything is operational. Therefore, this is the state in which the system should be most of the time. The switch is in bar configuration. No alarms are present from either the primary fiber or the secondary fiber.
Events:

Received No Protection: Move to state 1. Protection has been disabled.

Force Primary: Move to state 8. User has forced a move to primary link.

Force Secondary: Move to state 9. User has forced a move to secondary link.

Secondary Fail: Move to state 5. Primary link is still working well.

Primary Fail: Move to state 3. There is a failure in the primary link and the protection system is preparing to move to the secondary link for protection, via signaling.

Received Signaling: Move to state 4. This means (in most cases) that the other side of the link is signaling for a protection switching action in the optical switch on this side of the link.

| | |
|---|---|
| State 3: Send Signaling | Switch: signaling |

This state is a temporary state. In this state the local system on one side is trying to signal to the other side of the link that it has recognized a failure and that it wants to trigger a move from the primary link to the secondary link. In order to do this, the system sends a signaling message using both the primary and secondary links.
Events:

Received No Protection: Move to state 1. Protection has been disabled.

Force Primary: Move to state 8. User has forced a move to primary link.

Force Secondary: Move to state 9. User has forced a move to secondary link.

Finished Signaling: Move to state 4. The local system has waited for the signaling to reach the other side of the link and is then ready to reconfigure the optical switch.

| | |
|---|---|
| State 4: Primary Fail (CROSS) | Switch: cross |

In this state the local system moves the main traffic from the primary link to the secondary link by reconfiguration of the optical switch. The primary link is monitored to check when the failure is fixed.
Events:

Received No Protection: Move to state 1. Protection has been disabled.

Force Primary: Move to state 8. User has forced a move to primary link.

Force Secondary: Move to state 9. User has forced a move to secondary link.

Secondary Fail: Move to state 10. Both links have failed.

Primary OK: Move to state 7. The failure in the primary link has been fixed and the local system is preparing to move to the operational state keeping the switch in the cross position.

| | |
|---|---|
| State 5: Secondary Fail (BAR) | Switch: bar |

In this state the local system is moving the main traffic from the secondary link to the primary link by reconfiguration of the optical switch. The secondary link is monitored to check when the failure is fixed.
Events:

Received No Protection: Move to state 1. Protection has been disabled.

Force Primary: Move to state 8. User has forced a move to primary link.

Force Secondary: Move to state 9. User has forced a move to secondary link.

Primary Fail: Move to state 10. Both links have failed.

Secondary OK: Move to state 2. The failure in the secondary link has been fixed and the local system is preparing to move to the operational state keeping the switch in the bar position.

| | |
|---|---|
| State 6: Send Signaling | Switch: signaling |

This state is a temporary state. In this state the local system is trying to signal to the other side of the link that the local system has recognized a failure and the local system wants to trigger a move from the secondary link to the primary link. In order to do this, the local system is sending a signaling message using both the primary and secondary links.
Events:

Received No Protection: Move to state 1. Protection has been disabled.

Force Primary: Move to state 8. User has forced a move to primary link.

Force Secondary: Move to state 9. User has forced a move to secondary link.

Finished Signaling: Move to state 5. The system has waited for the signaling to reach the other side of the link and then the system is ready to reconfigure the optical switch.

| | |
|---|---|
| State 7: Operational (CROSS) | Switch: cross |

In this state everything is operational, and the local system is using the secondary link to pass the main traffic. The switch is in the cross configuration. No alarms are present from either the primary fiber or the secondary fiber.
Events:

Received No Protection: Move to state 1. Protection has been disabled.

Force Primary: Move to state 8. User has forced a move to primary link.

Force Secondary: Move to state 9. User has forced a move to secondary link.

Primary Fail: Move to state 4. Secondary link is still working well.

Secondary Fail or Revert: Move to state 6. There is a failure in the secondary link (or a command to revert back to the primary link) and the system is preparing to move to the primary link for protection, via signaling.

Received Signaling: Move to state 5. This means (in most cases) that the other side of the link is signaling for a protection switching action in the optical switch on this side of the link.

| | |
|---|---|
| State 8: Force Primary | Switch: bar |

This state is a forced state and therefore can only be exited by the clear command. In this state the local system is passing the main traffic signal using the primary link, no matter what the monitoring of the state of the link indicates.
Events:

Received No Protection: Move to state 1. Protection has been disabled.

Received Clear Force: Move to state 2. User has cleared the force command so the system is moving to the state where it keeps using the primary link for the main traffic.

Force Secondary: Move to state 9. User has forced a move to secondary link.

| | |
|---|---|
| State 9: Force Secondary | Switch: cross |

This state is a forced state and therefore can only be exited by the clear command. In this state the local system is passing the main traffic signal using the primary link, no matter what the monitoring of the state of the link indicates.
Events:

Received No Protection: Move to state 1. Protection has been disabled.

Received Clear Force: Move to state 7. User has cleared the force command so the system is moving to the state where it keeps using the secondary link for the main traffic.

Force Primary: Move to state 9. User has forced a move to primary link.

| | |
|---|---|
| State 10: Both Links Failed | Switch: as before |

In this state both the primary link and the secondary link have failed. The local system must therefore handle this situation as decided in the specific application (for example, block all switch connectivity).
Events:

Received No Protection: Move to state 1. Protection has been disabled.

Force Primary: Move to state 8. User has forced a move to primary link.

Force Secondary: Move to state 9. User has forced a move to secondary link.

Primary OK: Move to state 5. The failure in the primary link has been fixed and the local system is preparing to move the main traffic to the fixed link.

Secondary OK: Move to state 4. The failure in the secondary link has been fixed and the local system is preparing to move the main traffic to the fixed link.

In summary, the invention provides an all-optical system and methods of synchronizing and signaling across an optical network in order to coordinate protection schemes on an end-to-end basis. The methods include providing a protocol that supports multiple protection modes and is designed to pass across entire optical networks with a minimal change in the current infrastructure.

While the invention has been described with respect to a limited number of embodiments, it will be appreciated that many variations, modifications and other applications of the invention may be made.

What is claimed is:

1. In an optical communications network that includes at least one regular traffic link and at least one protection link, each said link connected at each of a transmitting and a receiving side to a protection system, an all-optical protection signaling method comprising the steps of:
a. detecting a failure in any at least one regular traffic link, thereby identifying at least one failed link;
b. optically notifying a transmitting side protection system of said failed link of said failure; and
c. switching regular traffic carried by said failed link to the at least one protection link;

2. The method of claim 1, further comprising the step of dropping extra traffic from said at least one protection link prior to said step of switching traffic.

3. The method of claim 2, further comprising the step of, upon detection of a repair of said failed link, switching said regular traffic back to said at least one regular traffic link, and returning said extra traffic to said at least one protection link.

4. The method of claim 1, wherein said step of detecting includes detecting said failure at a receiving side of said at least one failed link.

5. The method of claim 1, wherein said step of optically notifying includes providing a transparent optical signaling protocol.

6. The method of claim 5, wherein said step of switching includes synchronized switching by said transmitting side and said receiving side using said transparent optical signaling protocol.

7. The method of claim 1, wherein said step of switching includes switching for a protection selected from the group of fiber protection and optical channel protection.

8. The method of claim 7, wherein said switching for protection includes switching for dual ended protection.

9. The method of claim 7, wherein said switching for optical channel protection includes configuring a regenerator closest to each said protection system to ease the identification of failures allowing a simpler and more cost effective failure recognition.

10. The method of claim 9, wherein said configuring a regenerator closest to each said protection system to prevent unwanted switching to said protection link further includes stopping an optical signal from going into said transmitting side protection system if certain errors have been detected along said primary link by other regenerators positioned along said primary link.

11. The method of claim 8, wherein said switching for dual ended protection includes using a state machine to implement a dual ended 1:1 bi-directional mode protection.

12. The method of claim 11, wherein said using a state machine to implement a dual ended 1:1 bi-directional mode protection includes using said state machine to prevent misconnections.

13. A method for all-optical protection signaling in an optical communication network comprising the steps of:
a. detecting a failure in a primary link of the optical communications network; and
b. transparently signaling by optical means to at least one side of said primary link that said failure has been detected, thereby facilitating switching of optical traffic from said primary link to a protection link based on an transparent optical switching protocol.

14. The method of claim 13, wherein said switching is preceded by dropping extra traffic carried by said protection link.

15. The method of claim 14, wherein said step of detecting includes optically tapping said primary link.

16. The method of claim 15, wherein said step of transparently signaling by optical means further includes creating optical signaling messages in an optical switch connected to said primary and protection links and transmitting said optical messages to at least one protection system connected to said primary and protection links.

17. The method of claim 16, wherein said transmitting said optical messages to at least one protection system includes transmitting said optical messages to a protection system connected to a receiving side of said primary link.

18. The method of claim 16, wherein said transmitting said optical messages to at least one protection system includes transmitting said optical messages in a synchronized way to a protection system connected to both said receiving side and a transmitting side of said primary link.

19. The method of claim 14, further comprising the step of transparently signaling by optical means to said protection link that said primary link has been repaired, whereby the network switches said optical traffic back from said protection link to said primary link.

20. The method of claim 14, wherein said step of detecting includes detecting said failure at a receiving side of said primary link.

21. The method of claim 20, wherein said switching is synchronized between a transmitting side and said receiving side by said transparent optical switching protocol.

22. The method of claim 14, wherein said switching includes switching for a protection selected from the group of fiber protection and optical channel protection.

23. The method of claim 22, wherein said switching for protection includes switching for dual ended protection.

24. The method of claim 22, wherein said switching for optical channel protection includes configuring a regenerator closest to each said protection system to prevent unwanted switching to said protection link.

25. The method of claim 24, wherein said configuring a regenerator closest to each said protection system to prevent unwanted switching to said protection link further includes stopping an optical signal from going into said transmitting side protection system if certain errors have been detected along said primary link by other regenerators positioned along said primary link.

26. The method of claim 23, wherein said switching for dual ended protection includes using a state machine to implement a dual ended 1:1 bi-directional mode protection.

27. The method of claim 26, wherein said using a state machine to implement a dual ended 1:1 bi-directional mode protection includes using said state machine to prevent misconnections.

28. A system for all-optical protection in an optical network comprising:
a. a switch module operative to provide transparent optical protection signaling and switching in response to a failure indication, said switching including the switching of optical traffic from at least one primary link to at least one protection link; and
b. a failure indicating mechanism operative to provide said failure indication,
whereby said transparent optical protection signaling does not require any electronic messages.

29. The system of claim 28, wherein said failure indicating mechanism includes:
i. an optical taps module operative to tap into optical traffic carried by each said primary link and provide an output optical tap signal;
ii. a photodetector module operative to measure each said tap signal and provide an optical signal measurement; and
iii. a control module operative to trigger said protection switching in response to said optical signal measurement.

30. The system of claim 28, wherein said switch module includes a state machine operative to provide a transparent optical switching protocol that facilitates said switching.

31. The system of claim 28, implemented as a dual-ended bi-directional protection system.

32. The system of claim 28, implemented as a 1:N protection system.
